(19) United States
(12) Patent Application Publication
(10) Pub. No.: US 2025/0187259 A1
(43) Pub. Date: Jun. 12, 2025

(54) LIGHTING DEVICE

(71) Applicant: SIGNIFY HOLDING B.V., EINDHOVEN (NL)

(72) Inventors: RIFAT ATA MUSTAFA HIKMET, EINDHOVEN (NL); JACOBUS PETRUS JOHANNES VAN OS, EINDHOVEN (NL); TIES VAN BOMMEL, HORST (NL)

(21) Appl. No.: 18/875,059

(22) PCT Filed: Jun. 15, 2023
(86) PCT No.: PCT/EP2023/066101

§ 371 Date: Dec. 13, 2024

(30) Foreign Application Priority Data
Jun. 17, 2022 (EP) 22179498.5

(51) Int. Cl. B29C 64/118; B29C 64/124; B33Y 10/00; B33Y 40/20; B33Y 80/00

(52) U.S. Cl. CPC B29C 64/118; B29C 64/124; B33Y 10/00; B33Y 40/20; B33Y 80/00

(57) ABSTRACT

A lighting device comprising a light source and an object (100, 400, 600) is presented. The object (100, 400, 600) is configured as one or more of (i) at least part of a lighting device housing, (ii) at least part of a wall of a lighting chamber, and (iii) an optical element. The object (100, 400, 600) is manufactured by additive manufacturing using a first additive manufacturing material. The object (100, 400, 600) comprises a second object section (12, 42, 62) adjacent to a first object section (11, 41, 61), wherein the second object section (12, 42, 62) is separated from the first object section (11, 41, 61) by a section crease (20, 50).

### TECHNICAL FIELD

The present disclosure relates to a lighting device comprising a light source and an object that is configured as one or more of (i) at least part of a lighting device housing, (ii) at least part of a wall of a lighting chamber, and (iii) an optical element, wherein the object is manufactured by additive manufacturing. The present disclosure also relates to a method of manufacturing such a lighting device, as well as to a method of manufacturing a three-dimensional (3D) object. The method comprises additive manufacturing, for example by way of fused deposition modelling (FDM) or stereolithography (SLA).

### BACKGROUND

Manufacturing of a three-dimensional object from a digital 3D model, i.e., “digital manufacturing”, is expected to increasingly transform the nature of global manufacturing. One of the main processes used in digital manufacturing is additive manufacturing, often denoted “3D printing”. The term “3D printing” refers to processes wherein a material is joined or solidified under computer control to create a 3D object of almost any shape or geometry. Such 3D objects are typically produced using data from a 3D model, and usually by successively adding material layer by layer.

Devices for additive manufacturing include 3D printers configured to perform FDM or SLA. FDM 3D printers operate based on the principle “bottom down” where layers of a polymer are deposited, starting with a first layer deposited on a platform and subsequent layers on top of each other, producing a 3D object. In SLA 3D printers, a liquid photopolymer is illuminated and thereby solidifies the photopolymer layer by layer. SLA 3D printers may be based on the principle “bottom down” as well as the principle “bottom up”.

For printing long and broad objects, large printers are needed. However, such large printers are very expensive and require large spaces.

It is to be noted that in the present disclosure, the term additive manufacturing and 3D printing will be used interchangeably, and no limitation is to be interpreted from the specific choice of expression at any place in the disclosure.

### SUMMARY

In view of the above, an object of the present disclosure is to overcome drawbacks related to 3D printing of relatively long and broad objects.

This object is achieved in a first aspect by a method of manufacturing an object.

The method of the first aspect comprises the step of additive manufacturing of an object preform on a platform using a first additive manufacturing material. The object preform comprises a first object section and a second object section. The object sections are folded in relation to each other along a section crease. The object preform has a first extension along a first direction on the platform. The object preform is released from the platform and unfolded, whereby the object is obtained. The object has a second extension, larger than the first extension, along the first direction.

The method further comprises the steps of releasing the object preform from the platform, and unfolding the released object preform, whereby the object is obtained, and wherein the object has a second extension, larger than the first extension, along the first direction.

In other words, the method of the first aspect may be considered as a way of 3D printing in a “vertical and folded” manner. Given a desire to manufacture an object that has an extension that is larger, or even much larger, than the effective printing width and breadth of the platform of the 3D printer, the method of the first aspect enables a relatively small 3D printer to manufacture an object that has a relatively large extension in at least one direction. That is, by creating a vertical and folded object preform, which is unfolded subsequent to the printing, a relatively large object may be created by using a relatively small 3D printer.

For example, the object sections may be folded in relation to each other along the section crease by an angle less than or equal to 90 degrees. Moreover, to further accentuate the advantages, the additive manufacturing may comprise creating at least three object sections where the object has a second extension that is at least three times larger than the first extension along the first direction.

The additive manufacturing may be performed layer by layer, preferably in a spiralized fashion and preferably comprising creation of an unbroken perimeter path common to the object sections and the section crease, and creation of a plurality of further unbroken paths, within the perimeter path, common to the object sections and the section crease.

The additive manufacturing of the section crease may comprise creation of bridging parts between the object sections, wherein a bridging part width is smaller than an object section width.

By creating the object sections in such a spiralized manner, by continuous paths inside each other, it is possible to create thin bridging parts between the object sections in the form of only two paths.

The creation of bridging parts between the object sections may comprise using a second additive manufacturing material, different than the first additive manufacturing material.

By using a second additive manufacturing material for the bridging part that is more flexible than the first additive manufacturing material used for the object sections, it is possible to obtain a desired level of elasticity or flexibility of the crease between object sections.

The additive manufacturing may comprise creation of spatial distinctions that facilitate subsequent configuration of the object for a specific use. Such spatial distinctions may be protrusions and/or indentations on the object sections and they may be of any desired spatial shape required. For example, in cases where the object is to act in a light emitting context, the spatial distinctions may provide the shape of, e.g., a collimator and/or an exit window. Moreover, the spatial distinctions may comprise an additive manufacturing material that is different from any of the first and the second additive manufacturing material.

The additive manufacturing may comprise creation of a plurality of temporary jumper connectors connecting adjacent object sections, and the method may further comprise removing, prior to the unfolding, the temporary jumper connectors. Such jumper connectors provide an effect of stabilizing the object sections during the actual 3D printing, for example bending of the object sections is avoided. Such stabilizing may be necessary in cases where the object sections become relatively long, i.e. obtaining a large extension perpendicular to the printing platform.

The additive manufacturing may be an FDM process or an SLA process. An FDM process is advantageous in that, for example, the step of unfolding the object preform and any subsequent bending along the creases is made easy by the use of reheating the crease. Such reheating may be done by radiation heating or contact heating. If cooled down again in an un-bended state, the shape of the object remains in shape.

In a further aspect, there is provided a lighting device comprising a light source and an object that is configured as one or more of (i) at least part of a lighting device housing, (ii) at least part of a wall of a lighting chamber, and (iii) an optical element, wherein the object is manufactured by additive manufacturing using a first additive manufacturing material. The object comprises a first object section and a second object section adjacent to the first object section and separated from the first object section by a section crease.

The first and second object sections may have a tile shape, where said tile shape may have a length L, a width W and a thickness T. The first and second object sections may have a first major surface and a second major surface opposite to said first major surface. Said first and second major surfaces, defined by the length L and width W, may be arranged perpendicular to said platform during additive manufacturing. The first and second object sections may have a first, second, third and fourth side surfaces. The first and third side surface, defined by the width W and the thickness T, may be arranged opposite to each other. The first side surface may be arranged on the platform.

The section crease may comprise a bridging part between the object sections, where a bridging part width is smaller than an object section width. Such a bridging part between the object sections may comprise a second additive manufacturing material, different than the first additive manufacturing material.

Moreover, the section crease may have a cross-section of two additive manufacturing printing lines thick, e.g. without an air gap between the two, allowing optimal unfolding. The length of the section crease is preferably limited such that side surfaces of neighbouring objects sections may contact each other when unfolded.

Any of the first additive manufacturing material and the second additive manufacturing material may comprise a thermoplastic polymer having a melting temperature and/or a glass transition temperature.

The object may comprise spatial distinctions that facilitate subsequent configuration of the object for a specific use.

The object sections may be luminaire sections, and each luminaire section may comprise a collimator, e.g., made in a procedure comprising additive manufacturing.

These further aspects and embodiments of this further aspect provide the same effects and advantages as summarized above in connection with the method of the first aspect.

### BRIEF DESCRIPTION OF THE DRAWINGS

FIG. 1a is a perspective view that schematically illustrates a folded object preform on a platform,

FIG. 1b is a perspective view that schematically illustrates an object obtained by unfolding the object preform of FIG. 1a,

FIG. 2 is a flow chart of a method of manufacturing an object,

FIG. 3a is a perspective view that schematically illustrates a folded object preform on a platform,

FIG. 3b is a perspective view that schematically illustrates an object in the form of a luminaire obtained by unfolding the object preform of FIG. 3a,

FIG. 3c schematically illustrates a perimeter path during manufacturing of the object preform of FIG. 3a,

FIG. 3d is a side view that schematically illustrates the object of FIG. 3b,

FIG. 4a is a plan view that schematically illustrates an object preform,

FIG. 4b is a plan view that schematically illustrates an object obtained by unfolding the object preform of FIG. 4a,

FIG. 5a is a perspective view that schematically illustrates two object sections of an object preform, and

FIG. 5b schematically illustrates a perimeter path during manufacturing of the object sections of FIG. 5a.

### DETAILED DESCRIPTION

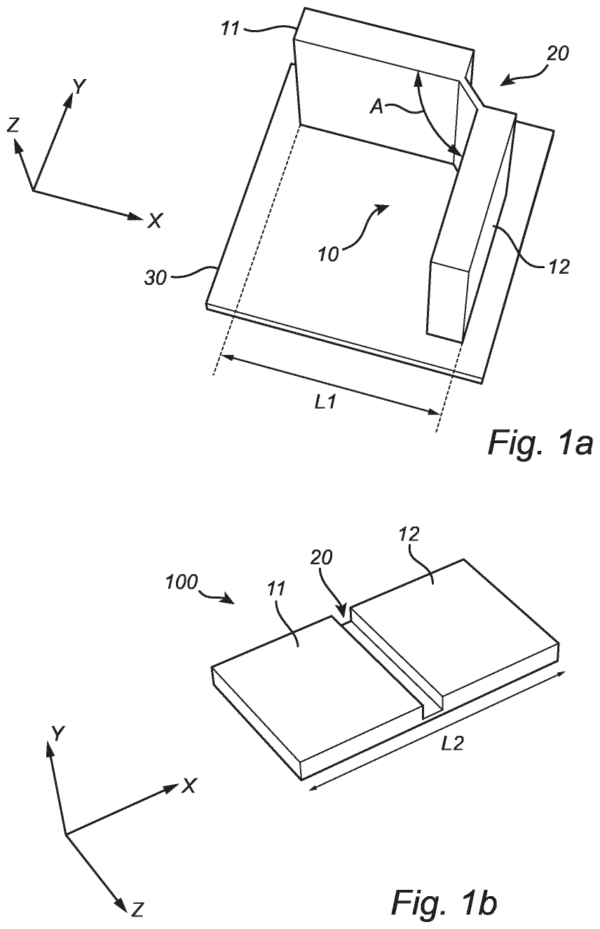

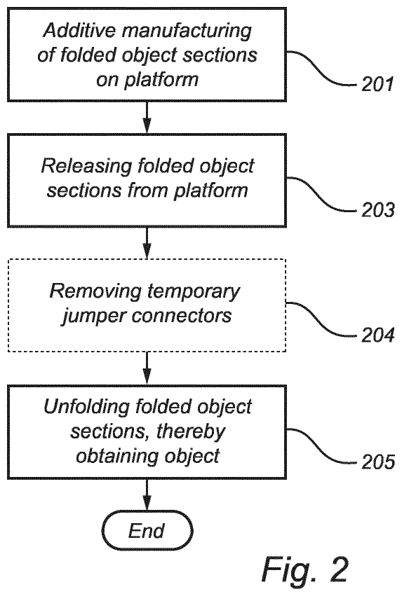

With reference to the flow chart in FIG. 2 and to the structural features schematically illustrated in FIGS. 1a and 1b, a method of manufacturing an object 100 comprises a number of manufacturing steps as follows:

### Step 201

Additive manufacturing of an object preform 10 is performed on a platform 30 using at least a first additive manufacturing material. As the skilled person will realize, the platform 30 may be a build plate of a 3D printer. The object preform 10 comprises a first object section 11 and a second object section 12, where the object sections 11, 12 are folded in relation to each other along a section crease 20. The object preform 10 has a first extension L1 along a first direction X on the platform 30.

The fact that the object sections 11, 12 are folded in relation to each other means that the object sections 11, 12 become arranged, or configured, in relation to each other in a folded fashion as a consequence of the additive manufacturing. Moreover, FIG. 1a illustrates one example of how a folded configuration of the object preform 10 may be realized in terms of geometry on the platform 30. That is, in FIG. 1a, the object sections 11, 12 are arranged at an angle A of 90° to each other in a plane defined by the X and Y directions. Other, more acute, angles A may be used as will be exemplified below.

### Step 203

The object preform 10 is then released from the platform 30. The actual release may be performed in any suitable manner, using suitable tools, as the skilled person will realize.

### Step 205

The object preform 10 that has been released in step 203 is then unfolded, whereby the object 100 is obtained. The object 100 has a second extension L2, larger than the first extension L1, along the first direction X. As exemplified in FIG. 1b, the step of unfolding may result in that the object sections 11, 12 become arranged at an angle (corresponding to the angle A in FIG. 1a) of 180° with respect to each other and form a common surface in a plane defined by the directions X and Z.

The actual unfolding may be performed in any suitable manner, using suitable tools, as the skilled person will realize.

As exemplified in FIG. 1a, the object sections 11, 12 may be folded in relation to each other along the section crease 20 by an angle A less than or equal to 90 degrees. However, other values on the acute angle A are possible, as will be exemplified below.

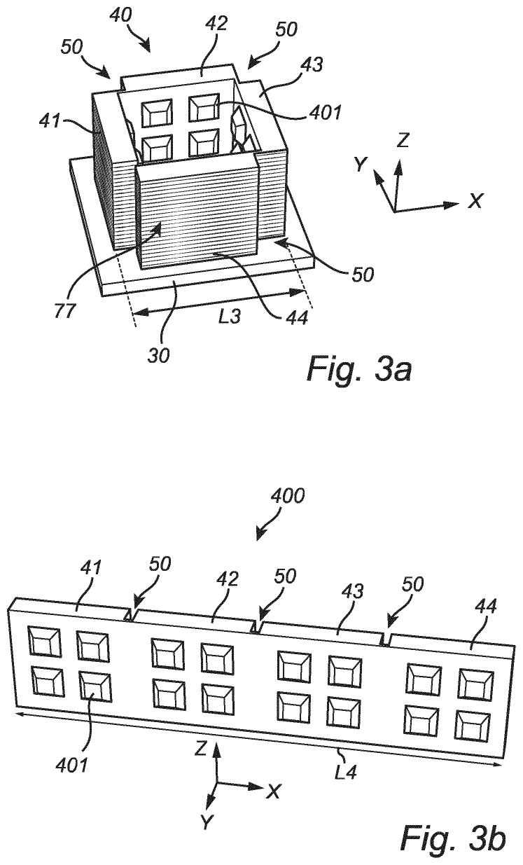

Turning now to FIGS. 3a and 3b, and with continued reference to FIG. 2, where a more complex arrangement than that of FIGS. 1a and 1b is illustrated. FIG. 3a illustrates an object preform 40, located on a platform 30, that comprises a first object section 41, a second object section 42, a third object section 43 and a fourth object section 44. As illustrated in FIG. 3a, a respective section crease 50 separates the first and second object sections 41, 42, the second and third object sections 42, 43 and the third and fourth object sections 43, 44. Here, the object preform 40 has a first extension L3 along a first direction X on the platform 30.

The object preform 40 is created by additive manufacturing in the manner described above in connection with step 201, released from the platform 30 as described above in step 203 and unfolded into an object 400 in step 205. Here, the object 400 has a second extension L4, larger than the first extension L3, along the first direction X.

FIGS. 3a and 3b accentuate the advantages of the present disclosure in that the additive manufacturing may comprise creating an object preform having several, e.g., at least three, object sections, and where the unfolded object has a second extension L4, corresponding to L2 of the object 100 in FIG. 1b, that is at least three times larger than the first extension L3, corresponding to L1 of the object preform 10 in FIG. 1a, along the first direction X.

As exemplified in FIGS. 3c and 3d, and with continued reference to FIG. 3a, the additive manufacturing 201 may be performed layer by layer 77 in a spiralized fashion. Such spiralized fashion comprises creation of an unbroken perimeter path 88 common to the object sections 41, 42, 43, 44 and the section crease 50. Arrows along the perimeter path 88 indicate that the direction of additive manufacturing is performed in a spiralized fashion. A plurality of further unbroken paths, one of which is indicated by path 89 in FIG. 3d, are also created within the perimeter path 88. These further unbroken paths 89 are also common to the object sections 41, 42, 43, 44 and the section crease 50. The number of stacked layers 77 created during the additive manufacturing 201 is preferably at least 20, more preferably at least 30 and most preferably at least 40.

FIG. 3d is a side view of the object 400 resulting from the unfolding of the object preform 40. As FIG. 3d exemplifies, the additive manufacturing 201 of the section crease 50 may comprise creation of bridging parts 55 between the object sections 41, 42, 43, 44, where a bridging part width T2 is smaller than an object section width T1.

The bridging parts 55 may be manufactured by use of the first additive manufacturing material, i.e., the same material used for creation of the object sections 41, 42, 43, 44. However, the creation of bridging parts 55 between the object sections 41, 42, 43, 44 may comprise using a second additive manufacturing material, different than the first additive manufacturing material. By using a second additive manufacturing material for the bridging part 55 that is more flexible than the first additive manufacturing material used for the object sections, it is possible to obtain a desired level of elasticity or flexibility of the crease 50. Furthermore, as exemplified in FIG. 3d, the bridging part 55 may be created by only two paths in the form of the peripheral path 88 adjoining itself during the spiralized creation, further accentuating the advantage in terms of providing optimal folding/unfolding characteristics of creating a thin crease 50. For example, the width of one path such as the peripheral path 88 may be 0.5 to 2.0 mm, which means that the bridging part width T2 may be 1.0 to 4 mm. It is, however, to be noted that the bridging part 55 may consist of only one single peripheral path 88, which means that the bridging part width T2 may be as small as 0.5 to 2.0 mm, depending on the path width used in the additive manufacturing step.

As indicated in FIGS. 3a and 3b, the object sections 41, 42, 43, 44 may be provided with spatial distinctions 401. That is, the additive manufacturing 201 may comprise creation of spatial distinctions 401 that facilitate subsequent configuration of the object 400 for a specific use. Such spatial distinctions 401 may be protrusions and/or indentations on the object sections 41, 42, 43, 44 and they may be of any desired spatial shape required. For example, in cases where the object 400 is to act in a light emitting context, the spatial distinctions 401 may provide the shape of, e.g., a collimator and/or an exit window. Moreover, the spatial distinctions 401 may comprise an additive manufacturing material that is the same or different from any of the first and the second additive manufacturing material used for the object sections 41, 42, 43, 44 and the bridging parts 55.

As the skilled person will realize, the process of creating, e.g., a luminaire from the unfolded object 400 will entail applying, e.g., a LED strip and other electronic arrangements on the object and then arranging the luminaire in a desired location.

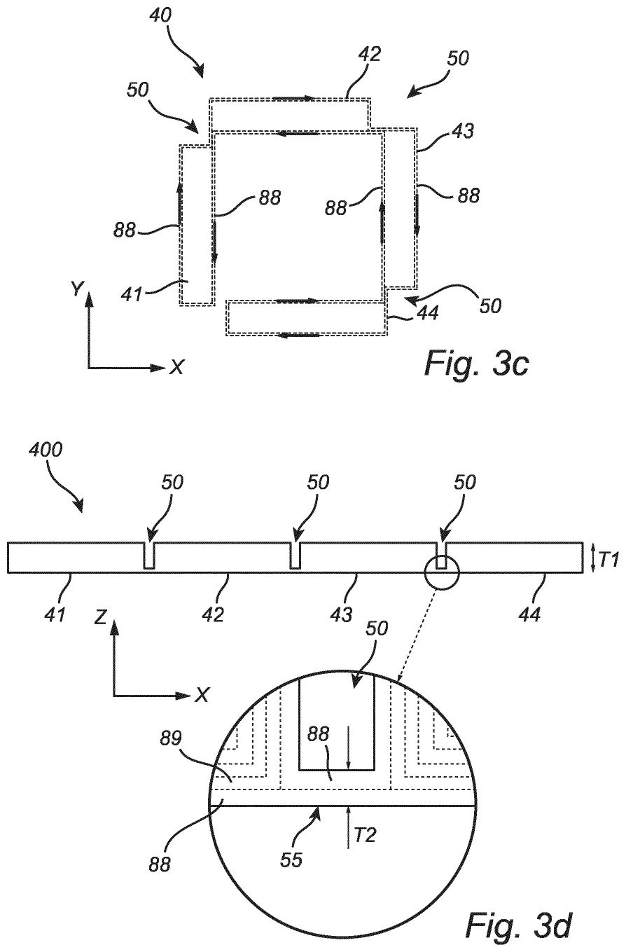

Turning now to FIG. 4a, and with continued reference to FIG. 2, which illustrates that an object preform 60 may comprise any number of object sections, here exemplified by eight object sections 61, 62, 63, 64, 65, 66, 67 and 68 respectively. A respective section crease may separate the object sections, which in FIG. 4a is indicated only by reference numeral 50 separating the second and third object sections 62, 63. The object preform 60 is created by additive manufacturing in the manner described above in connection with step 201, noting that the object sections 65, 66, 67 and 68 are arranged at an angle A (cf. FIG. 1a) of 0° to each other in a plane defined by the X and Y directions. The object preform 60 is released from a platform (not illustrated in FIG. 4a) as described above in step 203 and unfolded into an object 600 in step 205. The object preform 60 has an extension L3 along the first direction X.

As illustrated in FIG. 4b, the object 600, which is represented at the same spatial scale as the spatial scale of the object preform 60 in FIG. 4a, has an extension L4 along the first direction X that is clearly much larger than the extension L3 along the first direction X of the object preform 60. FIGS. 4a and 4b further accentuates the advantage that the method disclosed herein enables manufacturing of an object that has an extension that is much larger than the effective printing width and breadth of the 3D printer used for the additive manufacturing.

As exemplified by the object preform 60 in FIG. 4a, object sections may be arranged during the additive manufacturing 201 in relation to each other at an angle A that is 0° and 90° to each other in a plane defined by the X and Y directions. However, it is to be noted that other values (acute) on the angle A may be used in situations where a less tightly packed arrangement of the object sections in the object preform 600 is desired.

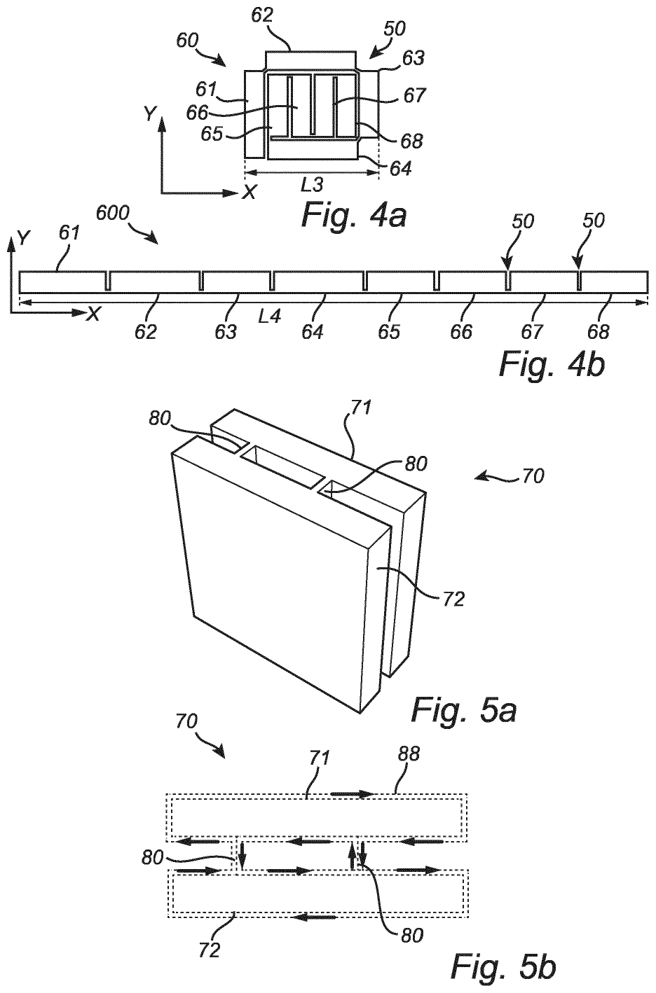

Referring now to FIGS. 5a and 5b, and with continued reference to FIG. 2, the additive manufacturing of an object preform 70 in step 201 may comprise creation of a plurality of temporary jumper connectors 80 connecting adjacent object sections 71, 72. As indicated in FIG. 5b, the additive manufacturing 201 may be performed in a spiralized fashion as indicated by the arrows along a perimeter path 88. The method may further comprise a step of removing 204, prior to the unfolding 205, the temporary jumper connectors 80. As indicated above, such jumper connectors 80 provide an effect of stabilizing the object sections 71, 72 during the additive manufacturing, for example bending of the object sections 71, 72 is avoided. Such stabilizing may be necessary in cases where the object sections 71, 72 become relatively long, i.e. obtaining a large extension perpendicular to the printing platform of the 3D printer used in the additive manufacturing.

A selection of material for the additive manufacturing of the object preform 10, 40, 60, 70, resulting in an object 100, 400, 600 made of such material, may comprise selecting a thermoplastic polymer having a melting temperature and/or a glass transition temperature. For example, use of a Polycarbonate is advantageous in an application where the step of unfolding 205 is the single one action of bending the object preform into an object. Folding/bending with the use of heating may be done with all kinds of thermoplastic materials. If multiple folding/bending is required and no thermal heating is used, use of a Polypropylene would be a very good option.

The object sections may be luminaire sections, and each luminaire section may comprise a collimator, e.g., made in a procedure comprising additive manufacturing.

A lighting device may comprise a light source and the object 100, 400, 600. The object 100, 400, 600 may be configured as one or more of (i) at least part of a lighting device housing, (ii) at least part of a wall of a lighting chamber, and (iii) an optical element. A luminaire, a lamp, or a light engine are all examples of a lighting device, and a light source may be a solid-state light source, such as a light emitting diode light source.

1. A lighting device comprising a light source and an object that is configured as one or more of (i) at least part of a lighting device housing, (ii) at least part of a wall of a lighting chamber, and (iii) an optical element, wherein the object is manufactured by additive manufacturing using a first additive manufacturing material, wherein the object comprises a first object section and a second object section adjacent to the first object section, and wherein the second object section is separated from the first object section by a section crease.

2. The lighting device according to claim 1, wherein the section crease comprises a bridging part between the first object section and the second object section, and wherein a bridging part width (T2) is smaller than an object section width.

3. The lighting device according to claim 2, wherein the bridging part comprises a second additive manufacturing material, different than the first additive manufacturing material.

4. The lighting device according to claim 1, comprising spatial distinctions that facilitate subsequent configuration of the object for a specific use.

5. A method of manufacturing a lighting device according to claim 1, the method comprising:
additive manufacturing of an object preform on a platform using the first additive manufacturing material, the object preform comprising the first object section and the second object section, where the first object section and the second object section are folded in relation to each other along the section crease and wherein the object preform has a first extension (L1, L3) along a first direction (X) on the platform;
releasing the object preform from the platform; and
unfolding the released object preform, whereby the object is obtained and where the object has a second extension (L2, L4), larger than the first extension (L1, L3), along the first direction (X).

6. The method according to claim 5, wherein the object sections are folded in relation to each other along the section crease by an angle (A) less than or equal to 90 degrees.

7. The method according to claim 5, wherein the additive manufacturing comprises creating at least three object sections and wherein the object has a second extension (L4) that is at least three times larger than the first extension (L3) along the first direction (X).

8. The method according to claim 5, wherein the additive manufacturing is performed layer by layer, preferably in a spiralized fashion, preferably comprising creation of an unbroken perimeter path common to the object sections and the section crease, and creation of a plurality of further unbroken paths, within the perimeter path, common to the object sections and the section crease.

9. The method according to claim 5, wherein the additive manufacturing of the section crease comprises creation of bridging parts between the object sections, wherein a bridging part width (T2) is smaller than an object section width (T1).

10. The method according to claim 9, wherein the creation of bridging parts between the object sections comprises using a second additive manufacturing material, different than the first additive manufacturing material.

11. The method according to claim 5, wherein the additive manufacturing comprises creation of spatial distinctions that facilitate subsequent configuration of the object for a specific use.

12. The method according to claim 5, wherein the additive manufacturing comprises creation of a plurality of temporary jumper connectors connecting adjacent object sections, and wherein the method further comprises:
removing, prior to the unfolding, the temporary jumper connectors.

13. The method according to claim 5, wherein the additive manufacturing is a fused deposition modelling, FDM, process or a stereolithography, SLA, process.

14. A method of manufacturing an object, the method comprising the steps of:
additive manufacturing of an object preform on a platform using a first additive manufacturing material, wherein the object preform comprises a first object section and a second object section, the first object section and the second object section being folded in relation to each other along a section crease, and wherein the object preform has a first extension (L1, L3) along a first direction (X) on the platform;
releasing the object preform from the platform; and
unfolding the released object preform, whereby the object is obtained, and wherein the object has a second extension (L2, L4), larger than the first extension (L1, L3), along the first direction (X),
wherein the step of additive manufacturing comprises creation of a plurality of temporary jumper connectors connecting adjacent object sections, and
wherein the method further comprises the step of:
removing, prior to the unfolding, the temporary jumper connectors.
